(19) United States
(12) Patent Application Publication
(10) Pub. No.: US 2013/0239777 A1
(43) Pub. Date: Sep. 19, 2013

(54) DRUMSTICK MOUNTED MUTABLE TAMBOURINE

(71) Applicants: Patrick Timothy Sullivan, Downy, CA (US); James Edward Brisco, La Habra, CA (US); Thomas Patrick Davis, Ontario, CA (US)

(72) Inventors: Patrick Timothy Sullivan, Downy, CA (US); James Edward Brisco, La Habra, CA (US); Thomas Patrick Davis, Ontario, CA (US)

(21) Appl. No.: 13/418,571

(22) Filed: Mar. 13, 2012

(51) Int. Cl. G10D 13/02

(52) U.S. Cl. 84/422.4

(57) ABSTRACT

A drumstick mountable mutable tambourine comprises a body mountable to the drumstick. A block may be attached to the body on which one or more mutable sound making devices are mountable. A muting device may be capable of actuation for muting the mutable sound making devices.

### BACKGROUND OF THE INVENTION

The present invention generally relates to a drumstick mounted mutable tambourine. More specifically, the invention relates to the present invention relates to a device that mutes and un-mutes a drumstick tambourine.

Attempts have been made to combine percussive instruments to extend the range of effects that a single percussionist can achieve, including providing a combination tambourine and drumstick.

However, there is a need for an instrument that combines a drumstick and a tambourine, but that is mutable.

### SUMMARY OF THE INVENTION

In one aspect of the present invention, a drumstick mountable mutable tambourine comprises a body mountable to the drumstick; a block attached to the body on which one or more mutable sound making devices are mountable; and a muting device capable of actuation for muting the mutable sound making devices.

In another aspect, a drumstick mountable mutable tambourine, comprises a tubular body mountable to the round drumstick; a block attached radially to the body on which one or more mutable sound making devices are mountable; and a muting device capable of actuation for muting the mutable sound making devices.

These and other features, aspects and advantages of the present invention will become better understood with reference to the following drawings, description and claims;

### BRIEF DESCRIPTION OF THE DRAWINGS

FIG. 1 is a perspective view of drumstick mounted mutable tambourine shown in use according to one embodiment;

FIG. 2 is an exploded view of the drumstick mounted mutable tambourine according to the embodiment of FIG. 1;

FIG. 3 is a sectional view of the drumstick mounted mutable tambourine along line 3-3 in FIG. 1; and

FIG. 4 is another sectional view of the drumstick mounted mutable tambourine of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

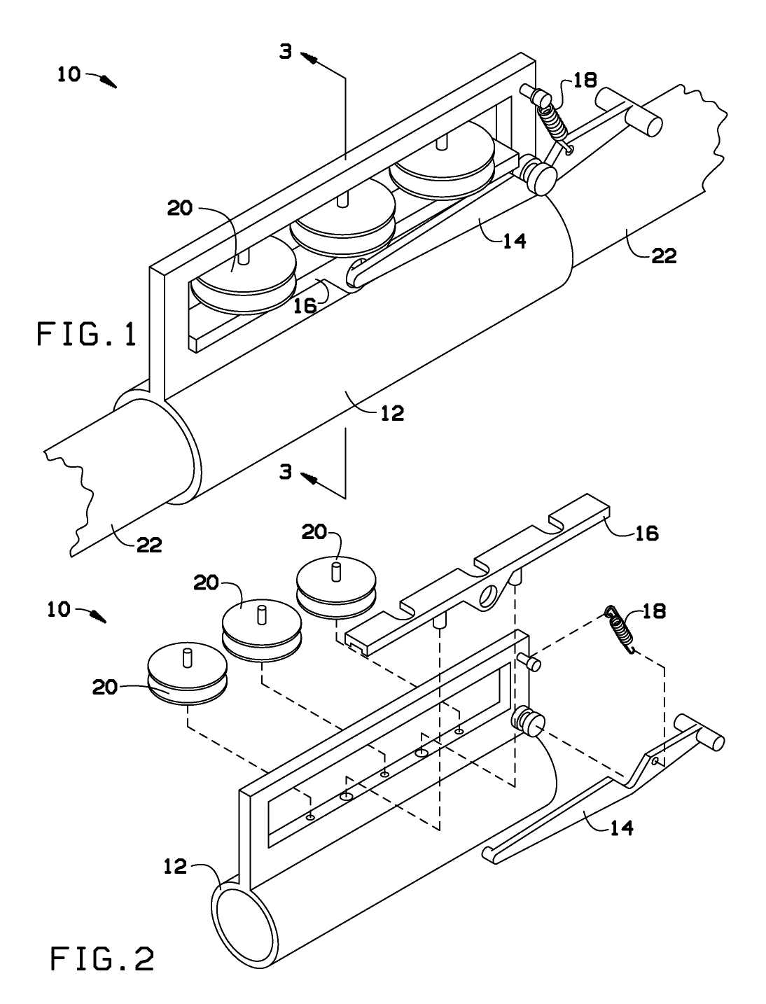

Broadly, embodiments of the present invention generally provide a drumstick mounted mutable tambourine. With reference to FIG. 1. a perspective view of a drumstick mounted mutable tambourine 10 is shown in use according to one embodiment. The tambourine 10 includes a body 12, which, in one embodiment, is tubular with a hollowed out block formed or attached therewith, so as to fit around a drumstick 22 with a round cross section.

The body 12 may support a block 16 under one or more cymbals 20 or other devices that may make sounds or jingle mounted within the hollowed rectangle portion of the body 12. The block 16 may be able to be moved into a position that dampens the cymbals 20 by means of a lever 14. The lever 14 may be biased by a spring 18 so the block 16 may be positioned in a non-dampened position. In this way, the tambourine 10 may normally be active so as to provide sound when shaken, and the user may press down on leaver as needed to mute the tambourine 16.

With reference to FIG. 2, an exploded view of the drumstick mounted mutable tambourine 10 according to the embodiment of FIG. 1 is shown. The hollowed rectangular portion of the body 12 may comprise a hollowed out rectangle of solid material in which three sets of cymbals 20 are placed. The block 16 may be placed across the bottom of the inside of the rectangular portion of the body 12 that may be pushed up by the thumb actuated lever 14 to mute the cymbals 20.

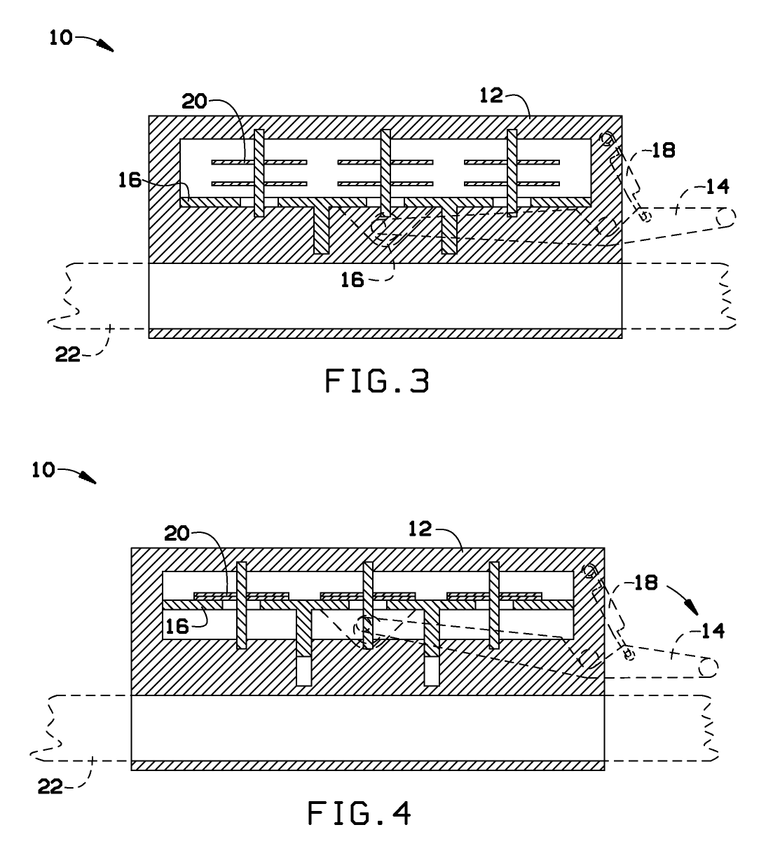

With reference to FIG. 3, a sectional view of the drumstick mounted mutable tambourine 10 along line 3-3 in FIG. 1 is shown. In FIG. 3, the lever 14 and block 16 are shown as when the cymbals 20 are in the non-muted position.

With reference to FIG. 4, another sectional view of the drumstick mounted mutable tambourine 10 along line 3-3 in FIG. 1 is shown. In FIG. 4, the lever 14 and block 16 are shown as when the cymbals 20 are in the muted position.

As those skilled in the art would recognize, other means may be used to mute cymbals 20, including by applying downward pressure to cymbals 20 instead of upward pressure. In any instance, the user may place the tambourine 20 on a drumstick 22 and play the drums as the user normally would, and press down on the mute lever 14 as needed to mute or un-mute tambourine 10.

It should be understood, of course, that the foregoing relates to exemplary embodiments of the invention and that modifications may be made without departing from the spirit and scope of the invention as set forth in the following claims.

1. A drumstick mountable mutable tambourine, comprising:
a body mountable to the drumstick;
a block attached to the body on which one or more mutable sound making devices are mountable; and
a muting device capable of actuation for muting the mutable sound making devices.

2. The drumstick mountable mutable tambourine of claim 1, wherein the sound making devices comprise one or more cymbals.

3. The drumstick mountable mutable tambourine of claim 2, wherein actuation device comprises a lever.

4. The drumstick mountable mutable tambourine of claim 3, wherein actuation device further comprises a block that is movable by the lever to mute the cymbals.

5. A drumstick mountable mutable tambourine, comprising:
a tubular body mountable to the round drumstick;
a block attached radially to the body on which one or more mutable sound making devices are mountable; and
a muting device capable of actuation for muting the mutable sound making devices.

6. The drumstick mountable mutable tambourine of claim 5, wherein the sound making devices comprise one or more cymbals.

7. The drumstick mountable mutable tambourine of claim 6, wherein actuation device comprises a lever.

8. The drumstick mountable mutable tambourine of claim 7, wherein actuation device further comprises a block that is movable by the lever to mute the cymbals.
